(19) United States
(12) Patent Application Publication
(10) Pub. No.: US 2007/0081591 A1
(43) Pub. Date: Apr. 12, 2007

(54) Method and apparatus for coding moving picture frame to reduce flickering

(75) Inventor: Tae-gyoung Ahn, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/499,702

(22) Filed: Aug. 7, 2006

(30) Foreign Application Priority Data
Oct. 6, 2005 (KR) 10-2005-0093911

(51) Int. Cl. H04N 7/12

(52) U.S. Cl. 375/240.14; 375/240.26

(57) ABSTRACT

A method and apparatus are provided for coding a moving picture frame to reduce flickering. The method includes generating an inter-reconstructed image by performing interprediction on a moving picture frame to be coded, generating an intra-reconstructed image by performing intraprediction on the moving picture frame, generating a first difference image between the inter-reconstructed image and the intra-reconstructed image, and generating a second difference image by adding the first difference image and an intra difference image generated during the intraprediction.

### CROSS-REFERENCE TO RELATED PATENT APPLICATION

This application priority from Korean Patent Application No. 10-2005-0093911, filed on Oct. 6, 2005, in the Korean Intellectual Property Office, the disclosure of which is incorporated herein in its entirety by reference.

### BACKGROUND OF THE INVENTION

1. Field of the Invention

Methods and apparatuses consistent with the present invention relate to coding a moving picture frame, and more particularly, to coding a moving picture frame to reduce flickering in an intra (I) frame or an instantaneous decoding refresh (IDR)-I frame during reproducing moving picture.

2. Description of the Related Art

Most moving picture compression codecs use intra (I) frames or instantaneous decoding refresh (IDR)-I frames for reproduction from a random data position. However, when I frames or IDR-I frames are used, they have no correlation with temporally previous frames, causing flickering during the reproduction of a moving picture.

### SUMMARY OF THE INVENTION

The present invention provides a method and apparatus for coding a moving picture frame to reduce flickering when an I frame or an instantaneous decoding refresh IDR-I frame is used.

The present invention also provides a computer-readable recording medium having recorded thereon a program for implementing the method for coding a moving picture frame on a computer.

According to an aspect of the present invention, there is provided a method for coding a moving picture frame. The method includes generating an inter-reconstructed image by performing interprediction on a moving picture frame to be coded, generating an intra-reconstructed image by performing intraprediction on the moving picture frame, generating a first difference image between the inter-reconstructed image and the intra-reconstructed image, and generating a second difference image by adding the first difference image and an intra difference image generated during the intraprediction.

According to another aspect of the present invention, there is provided a method for coding a moving picture frame. The method includes determining a coding mode for a moving picture frame to be coded by comparing costs of intraprediction and interprediction, coding the moving picture frame by performing intraprediction if the coding mode is an intra mode, generating an inter-reconstructed image through interprediction and an intra-reconstructed image through intraprediction for the moving picture frame if the coding mode is an inter mode, generating a first difference image between the inter-reconstructed image and the intra-reconstructed image if the coding mode is the inter mode, and generating a second difference image by adding the first difference image and an intra difference image generated during the intraprediction if the coding mode is the inter mode.

According to still another aspect of the present invention, there is provided an apparatus for coding a moving picture frame. The apparatus includes an inter reconstructing unit, an intra reconstructing unit, a first difference image generating unit, and a second difference image generating unit. The inter reconstructing unit generates an inter-reconstructed image by performing interprediction on a moving picture frame to be coded. The intra reconstructing unit generates an intra-reconstructed image by performing intraprediction on the moving picture frame. The first difference image generating unit generates a first difference image between the inter-reconstructed image and the intra-reconstructed image. The second difference image generating unit generates a second difference image by adding the first difference image and an intra difference image generated during the intraprediction.

According to yet another aspect of the present invention, there is provided an apparatus for coding a moving picture frame. The apparatus includes a mode determining unit, an intra mode coding unit, a reconstructed image generating unit, a first difference image generating unit, and a second difference image generating unit. The mode determining unit determines a coding mode for a moving picture frame to be coded by comparing costs of intraprediction and interprediction. The intra mode coding unit codes the moving picture frame by performing intraprediction if the coding mode is an intra mode. The reconstructed image generating unit generates an inter-reconstructed image through interprediction and an intra-reconstructed image through intraprediction for the moving picture frame if the coding mode is an inter mode. The first difference image generating unit generates a first difference image between the inter-reconstructed image and the intra-reconstructed image if the coding mode is the inter mode. The second difference image generating unit generates a second difference image by adding the first difference image and an intra difference image generated during the intraprediction if the coding mode is the inter mode.

### BRIEF DESCRIPTION OF THE DRAWINGS

The above and other aspects of the present invention will become more apparent by describing in detail exemplary embodiments thereof with reference to the attached drawings in which:

FIGS. 1A through 1C illustrate the structure of a group of pictures;

FIG. 2 is a block diagram of an apparatus for coding a moving picture frame according to an exemplary embodiment of the present invention;

FIG. 3 is a flowchart illustrating a method for coding a moving picture frame according to an exemplary embodiment of the present invention;

FIG. 4 is a block diagram of an inter reconstructing unit according to an exemplary embodiment of the present invention;

FIG. 5 is a block diagram of an intra reconstructing unit according to an exemplary embodiment of the present invention; and

FIG. 6 is a block diagram of an apparatus for coding a moving picture frame according to an exemplary embodiment of the present invention.

### DETAILED DESCRIPTION OF EXEMPLARY EMBODIMENTS OF THE INVENTION

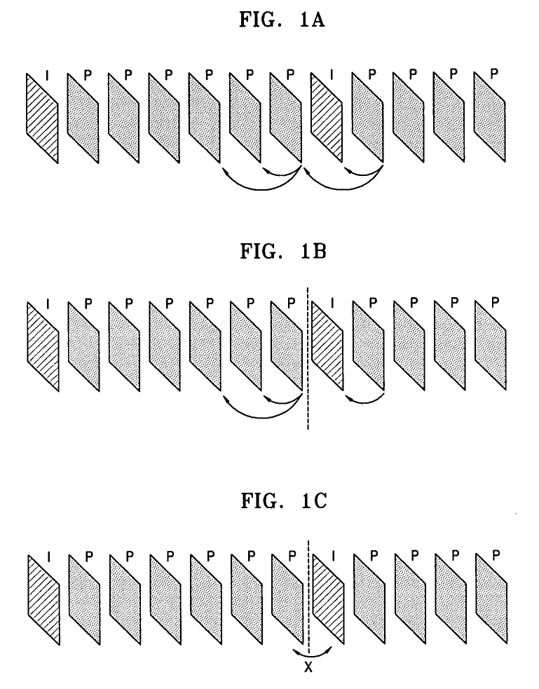

FIGS. 1A through 1C illustrate the structure of a group of pictures (GOP) to explain an I frame and an instantaneous decoding refresh IDR-I frame.

The I frame is a frame used in Moving Picture Expert Group (MPEG)-2 or MPEG-4 and is coded or decoded without reference to other frames. Referring to FIG. 1A, a difference between the I frame and a P frame can be seen. The P frame is coded or decoded with reference to other frames (I frames and/or P frames). As shown in FIG. 1A, a P frame referring to an I frame can also refer to a P frame previous to the referred I frame.

The IDR-I frame is a frame used in H.264 and is also coded or decoded without reference to other frames. FIG. 1B shows the case of using the IDR-I frame. By comparing FIGS. 1A and 1B, a difference between the case of using an I frame and the case of using an IDR-I frame can be seen. A P frame referring to an IDR-I frame cannot refer to a P frame or an I frame previous to its referred I frame. For example, referring to FIG. 1B, a P frame at the right side of a dotted line cannot refer to a P frame at the left side of the dotted line.

FIG. 1C shows that when an IDR-I frame is used, frames at the left side and the right side of the dotted line have no correlation. However, when an I frame is used, the I frame and its previous P frames have no correlation. This is because the P frames previous to the I frame do not refer to a following I frame. Thus, FIG. 1C is also applied to an I frame.

An I frame or an IDR-I frame allows the reproduction of a moving picture at a random position. However, since the I frame or the IDR-I frame has no correlation with its previous P frames as shown in FIG. 1C, flickering occurs around the I frame or the IDR-I frame during the reproduction of the moving picture. Flickering gets worse as a compression technique becomes complicated and image quality decreases.

As an approach to solve flickering, image quality at a portion where human eyes easily perceive flickering can be improved by reducing a quantization parameter (QP) and image quality at the remaining portion can be degraded by increasing the QP. However, the problems of the approach are that image quality higher than a predetermined level is required and it has no effect when image quality is low. Moreover, since many bits should be assigned, the entire image quality is degraded.

A method and apparatus for coding a moving picture frame according to the exemplary embodiments of the present invention may reduce flickering by causing an I frame or an IDR-I frame to have correlation with its previous frames through interprediction as well as intraprediction during coding of the I frame or the IDR-I frame.

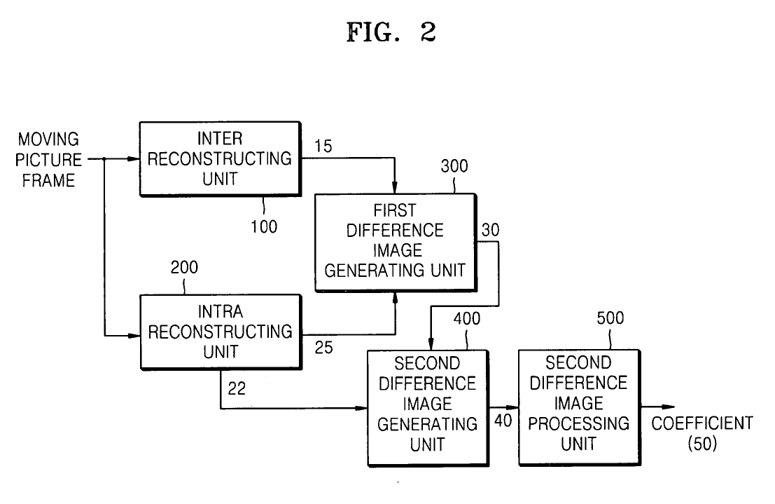

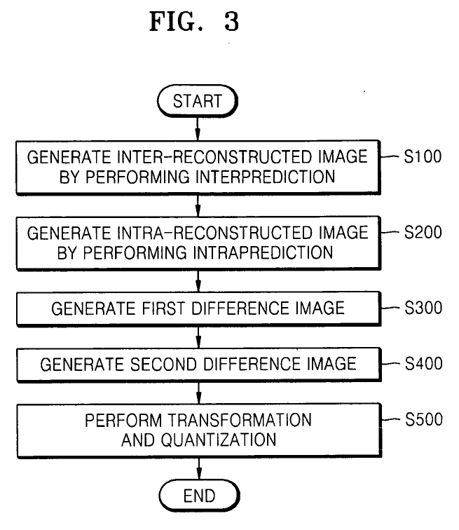

FIG. 2 is a block diagram of an apparatus for coding a moving picture frame according to an exemplary embodiment of the present invention, and FIG. 3 is a flowchart illustrating a method for coding a moving picture frame according to an exemplary embodiment of the present invention.

Referring to FIG. 2, the apparatus for coding a moving picture frame includes an inter reconstructing unit 100, an intra reconstructing unit 200, a first difference image generating unit 300, a second difference image generating unit 400, and a second difference image processing unit 500.

The inter reconstructing unit 100 generates an inter-reconstructed image 15 by performing interprediction on the moving picture frame to be coded (S100 of FIG. 3)

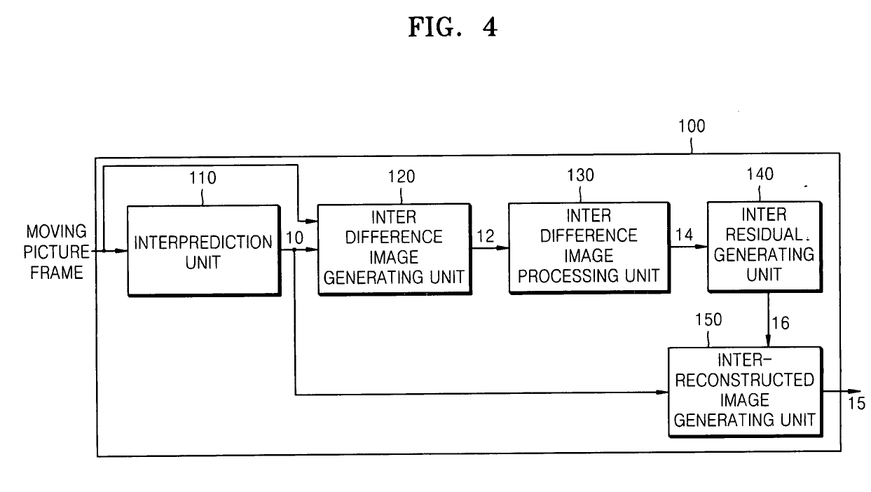

FIG. 4 is a block diagram of the inter reconstructing unit 100 according to an exemplary embodiment of the present invention.

Referring to FIG. 4, the inter reconstructing unit 100 includes an interprediction unit 110, an inter difference image generating unit 120, an inter difference image processing unit 130, an inter residual generating unit 140, and an inter-reconstructed image generating unit 150.

The interprediction unit 110 generates an interprediction image 10 by performing performs interprediction on the moving picture frame to be coded.

The inter difference image generating unit 120 generates an inter difference image 12 by subtracting the interprediction image 10 from the moving picture frame to be coded.

The inter difference image processing unit 130 performs transformation and quantization (TnQ) on the inter difference image 12.

The inter residual image generating unit 140 generates an inter residual 16 by performing inverse transformation and quantization (ITnQ) on the transformed and quantized inter difference image 14.

The inter-reconstructed image generating unit 150 generates the inter-reconstructed image 15 by adding the inter residual 16 to the interprediction image 10.

The intra reconstructing unit 200 generate an intra-reconstructed image 25 by performing intraprediction on the moving picture frame to be coded (S200 of FIG. 3)

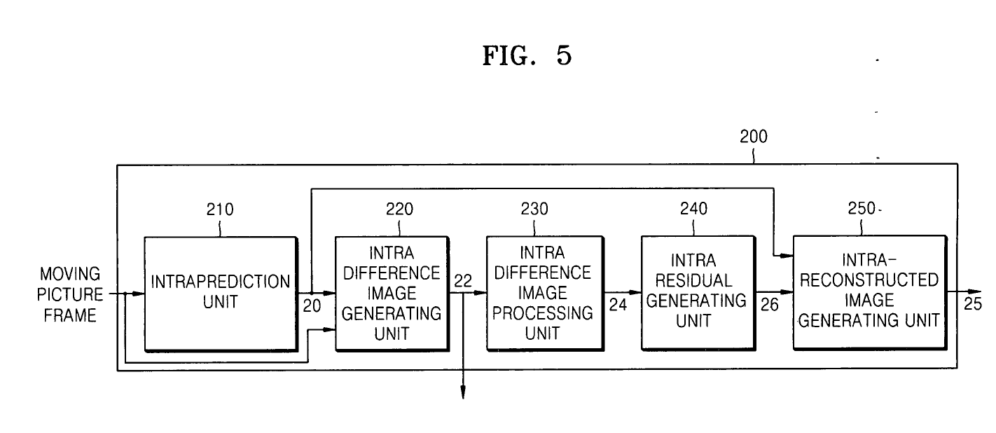

FIG. 5 is a block diagram of the intra reconstructing unit 200 according to the present invention.

Referring to FIG. 5, the intra reconstructing unit 200 includes an intraprediction unit 210, an intra difference image generating unit 220, an intra difference image processing unit 230, an intra residual generating unit 240, and an intra-reconstructed image generating unit 250.

The intraprediction unit 210 generates an intraprediction image 20 by performing intraprediction on the moving picture frame to be coded.

The intra difference image generating unit 220 generates an intra difference image 22 by subtracting the intraprediction image 20 from the moving picture frame to be coded.

The intra difference image processing unit 230 performs TnQ on the intra difference image 22.

The intra residual generating unit 240 generates an intra residual 26 by performing ITnQ on the transformed and quantized intra difference image 24.

The intra-reconstructed image generating unit 250 generates the intra-reconstructed image 25 by adding the intra residual 26 to the intraprediction image 20.

The first difference image generating unit 300 generates a first different image 30 between the inter-reconstructed image 15 and the intra-reconstructed image 25 (S300 of FIG. 3).

The second difference image generating unit 400 generates a second difference image 40 by adding the first difference image 30 and the intra difference image 22 (S400 of FIG. 3).

The second difference image processing unit 500 generates a coefficient 50 by performing TnQ on the second difference image 40 (S500 of FIG. 3). The generated coefficient 50 is transmitted after being entropy encoded.

In the method for coding a moving picture frame according to the exemplary embodiment of the present invention, the effect of coding using interprediction is added to an I frame or an IDR-I frame coded using intraprediction, thereby reducing flickering. This is based on the assumption that coding using interprediction causes less flickering than coding using intraprediction. However, coding using interprediction does not necessarily causes less flickering than coding using intraprediction. In some cases, coding only using intraprediction may cause less flickering than coding using both interprediction and intraprediction. Thus, a determination should be first made about whether coding using only intraprediction or coding according to the present invention should be applied to a moving picture frame to be coded.

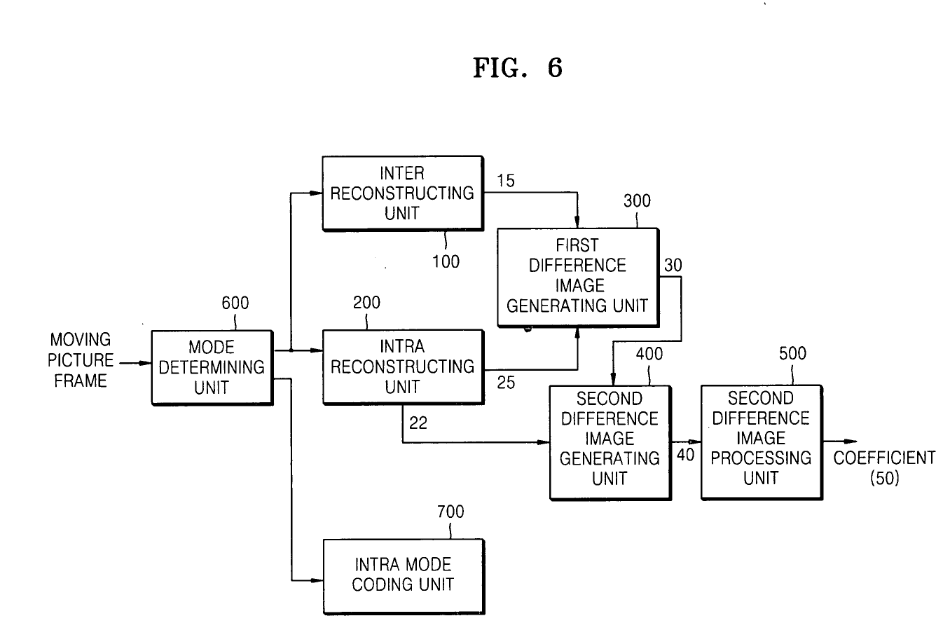

FIG. 6 is a block diagram of an apparatus for coding a moving picture frame according to an exemplary embodiment of the present invention. The apparatus for coding a moving picture frame includes a mode determining unit 600, an intra mode coding unit 700, an inter reconstructing unit 100, an intra reconstructing unit 200, a first difference image generating unit 300, a second difference image generating unit 400, and a second difference image processing unit 500.

First, both intraprediction and interprediction are applied to a moving picture frame to be coded. The mode determining unit 600 determines a coding mode by comparing costs of intraprediction and interprediction.

When the cost of intraprediction is smaller than that of interprediction, coding using intraprediction causes less flickering. Thus, the moving picture frame is coded only using intraprediction by the intra mode coding unit 700.

When the cost of interprediction is smaller than that of intraprediction, coding according to the present invention causes less flickering. Therefore, only when the determined coding mode is an inter mode, the moving picture frame is coded using the inter reconstructing unit 100, the intra reconstructing unit 200, the first difference image generating unit 300, the second difference image generating unit 400, and the second difference image processing unit 500 as described previously with reference to FIGS. 2 to 5.

By comparing costs of intraprediction and interprediction and selectively applying coding using intraprediction or coding according to the present invention according to the determined coding mode, flickering can be reduced in both coding modes.

As described above, according to the present invention, an I frame or an IDR-I frame can have correlation with its previous frames through interprediction as well as intraprediction during coding of the I frame or the IDR-I frame, thereby reducing flickering.

In addition, by comparing costs of intraprediction and interprediction and selectively applying coding using intraprediction or coding according to the present invention to the moving picture frame to be coded according to the determined coding mode, flickering can be reduced in both coding modes.

Meanwhile, the present invention can be embodied as code that is readable by a computer (including all devices having an information processing function) on a computer-readable recording medium. The computer-readable recording medium includes all kinds of recording devices storing data that is readable by a computer system. Examples of the computer-readable recording medium include read-only memory (ROM), random access memory (RAM), CD-ROMs, magnetic tapes, floppy disks, and optical data storage devices.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method for coding a moving picture frame, the method comprising:
generating an inter-reconstructed image by performing interprediction on a moving picture frame to be coded;
generating an intra-reconstructed image and an intra difference image by performing intraprediction on the moving picture frame;
generating a first difference image between the inter-reconstructed image and the intra-reconstructed image; and
generating a second difference image by adding the first difference image and the intra difference image.

2. The method of claim 1, further comprising performing transformation and quantization on the second difference image.

3. The method of claim 1, wherein the generating the inter-reconstructed image comprises:
generating an interprediction image by performing interprediction on the moving picture frame;
generating an inter difference image by subtracting the interprediction image from the moving picture frame;
performing transformation and quantization on the inter difference image;
generating an inter residual by performing inverse transformation and quantization on the transformed and quantized inter difference image; and
generating the inter-reconstructed image by adding the inter residual to the interprediction image.

4. The method of claim 1, wherein the generating the intra-reconstructed image comprises:
generating an intraprediction image by performing intraprediction on the moving picture frame;
generating the intra difference image by subtracting the intraprediction image from the moving picture frame;
performing transformation and quantization on the intra difference image;
generating an intra residual by performing inverse transformation and quantization on the transformed and quantized intra difference image; and
generating the intra-reconstructed image by adding the intra residual to the intraprediction image.

5. The method of claim 1, wherein the moving picture frame is an intra frame or an instantaneous decoding refresh-intra frame.

6. A method for coding a moving picture frame, the method comprising:
determining a coding mode for a moving picture frame to be coded by comparing costs of intraprediction and interprediction;
coding the moving picture frame by performing intraprediction if the coding mode is determined to be an intra mode;
generating an inter-reconstructed image by performing interprediction on the moving picture frame and generating an intra-reconstructed image and an intra difference image by performing intraprediction on the moving picture frame if the coding mode is determined to be an inter mode;
generating a first difference image between the inter-reconstructed image and the intra-reconstructed image if the coding mode is determined to be the inter mode; and
generating a second difference image by adding the first difference image and the intra difference image if the coding mode is determined to be the inter mode.

7. The method of claim 6, further comprising performing transformation and quantization on the second difference image if the coding mode is determined to be the inter mode.

8. The method of claim 6, wherein the generating the inter-reconstructed image comprises:
generating an interprediction image by performing interprediction on the moving picture frame;
generating an inter difference image by subtracting the interprediction image from the moving picture frame;
performing transformation and quantization on the inter difference image;
generating an inter residual by performing inverse transformation and quantization on the transformed and quantized inter difference image; and
generating the inter-reconstructed image by adding the inter residual to the interprediction image.

9. The method of claim 6, wherein the generating the intra-reconstructed image and the intra difference image comprises:
generating an intraprediction image by performing intraprediction on the moving picture frame;
generating the intra difference image by subtracting the intraprediction image from the moving picture frame;
performing transformation and quantization on the intra difference image;
generating an intra residual by performing inverse transformation and quantization on the transformed and quantized intra difference image; and
generating the intra-reconstructed image by adding the intra residual to the intraprediction image.

10. The method of claim 6, wherein the moving picture frame is an intra frame or an instantaneous decoding refresh-intra frame.

11. An apparatus for coding a moving picture frame, the apparatus comprising:
an inter reconstructing unit which generates an inter-reconstructed image by performing interprediction on a moving picture frame to be coded;
an intra reconstructing unit which generates an intra-reconstructed image and an intra difference image by performing intraprediction on the moving picture frame;
a first difference image generating unit which generates a first difference image between the inter-reconstructed image and the intra-reconstructed image; and
a second difference image generating unit which generates a second difference image by adding the first difference image and the intra difference image.

12. The apparatus of claim 11, further comprising a second difference image processing unit which performs transformation and quantization on the second difference image.

13. The apparatus of claim 11, wherein the inter reconstructing unit comprises:
an interprediction unit which generates an interprediction image by performing interprediction on the moving picture frame;
an inter difference image generating unit which generates an inter difference image by subtracting the interprediction image from the moving picture frame;
an inter difference image processing unit which performs transformation and quantization on the inter difference image;
an inter residual generating unit which generates an inter residual by performing inverse transformation and quantization on the transformed and quantized inter difference image; and
an inter-reconstructed image generating unit which generates the inter-reconstructed image by adding the inter residual to the interprediction image.

14. The apparatus of claim 11, wherein the intra reconstructing unit comprises:
an intraprediction unit which generates an intraprediction image by performing intraprediction on the moving picture frame;
an intra difference image which generates unit generating the intra difference image by subtracting the intraprediction image from the moving picture frame;
an intra difference image processing unit which performs transformation and quantization on the intra difference image;
an intra residual generating unit which generates an intra residual by performing inverse transformation and quantization on the transformed and quantized intra difference image; and
an intra-reconstructed image generating unit which generates the intra-reconstructed image by adding the intra residual to the intraprediction image.

15. The apparatus of claim 11, wherein the moving picture frame is an intra frame or an instantaneous decoding refresh-intra frame.

16. A apparatus for coding a moving picture frame, the apparatus comprising:
a mode determining unit which determines a coding mode for a moving picture frame to be coded by comparing costs of intraprediction and interprediction;
an intra mode coding unit which codes the moving picture frame by performing intraprediction if the coding mode is determined to be an intra mode;
a reconstructed image generating unit which generates an inter-reconstructed image by performing interprediction on the moving picture frame and generates an intra-reconstructed image and an intra difference image by performing intraprediction on the moving picture frame if the coding mode is determined to be an inter mode;
a first difference image generating unit which generates a first difference image between the inter-reconstructed image and the intra-reconstructed image if the coding mode is determined to be the inter mode;
a second difference image generating unit which generates a second difference image by adding the first difference image and the intra difference image if the coding mode is determined to be the inter mode.

17. The apparatus of claim 16, further comprising a difference image processing unit which performs transformation and quantization on the second difference image if the coding mode is determined to be the inter mode.

18. The apparatus of claim 16, wherein the reconstructed image generating unit comprises:
an interprediction unit which generates an interprediction image by performing interprediction on the moving picture frame;
an inter difference image generating unit which generates an inter difference image by subtracting the interprediction image from the moving picture frame;
an inter difference image processing unit which performs transformation and quantization on the inter difference image;
an inter residual generating unit which generates an inter residual by performing inverse transformation and quantization on the transformed and quantized inter difference image; and
an inter-reconstructed image generating unit which generates the inter-reconstructed image by adding the inter residual to the interprediction image.

19. The apparatus of claim 16, wherein the reconstructed image generating unit comprises:
an intraprediction unit which generates an intraprediction image by performing intraprediction on the moving picture frame;
an intra difference image generating unit which generates the intra difference image by subtracting the intraprediction image from the moving picture frame;
an intra difference image processing unit which performs transformation and quantization on the intra difference image;
an intra residual generating unit which generates an intra residual by performing inverse transformation and quantization on the transformed and quantized intra difference image; and
an intra-reconstructed image generating unit which generates the intra-reconstructed image by adding the intra residual to the intraprediction image.

20. The apparatus of claim 16, wherein the moving picture frame is an intra frame or an instantaneous decoding refresh-intra frame.

21. A computer-readable recording medium having recorded thereon a program for implementing a method for coding a moving picture frame on a computer, the method comprising:
generating an inter-reconstructed image by performing interprediction on a moving picture frame to be coded;
generating an intra-reconstructed image and an intra difference image by performing intraprediction on the moving picture frame;
generating a first difference image between the inter-reconstructed image and the intra-reconstructed image; and
generating a second difference image by adding the first difference image and the intra difference image.

22. A computer-readable recording medium having recorded thereon a program for implementing a method for coding a moving picture frame on a computer, the method comprising:
determining a coding mode for a moving picture frame to be coded by comparing costs of intraprediction and interprediction;
coding the moving picture frame by performing intraprediction if the coding mode is determined to be an intra mode;
generating an inter-reconstructed image by performing interprediction on the moving picture frame and generating an intra-reconstructed image and an intra difference image by performing intraprediction on the moving picture frame if the coding mode is determined to be an inter mode;
generating a first difference image between the inter-reconstructed image and the intra-reconstructed image if the coding mode is determined to be the inter mode; and
generating a second difference image by adding the first difference image and the intra difference image if the coding mode is determined to be the inter mode.
